(19) United States
(12) Patent Application Publication
(10) Pub. No.: US 2014/0153416 A1
(43) Pub. Date: Jun. 5, 2014

(54) METHOD, WIRELESS COMMUNICATION STATION, AND SYSTEM FOR REDUCING DATA STARVATION

(71) Applicants: Shai Brandes, Haifa (IL); Shai Ostshega, Binyamina (IL); Alexander Tolpin, Netanya (IL); Amit Bernstein, Haifa (IL)

(72) Inventors: Shai Brandes, Haifa (IL); Shai Ostshega, Binyamina (IL); Alexander Tolpin, Netanya (IL); Amit Bernstein, Haifa (IL)

(21) Appl. No.: 13/692,332

(22) Filed: Dec. 3, 2012

(51) Int. Cl. H04W 24/04; H04W 84/12

(52) U.S. Cl. CPC H04W 24/04; H04W 84/12
USPC 370/252; 370/338

(57) ABSTRACT

Embodiments of a wireless communication station and methods for reducing data starvation are generally described herein. In some embodiments, a wireless communications station passes data packets stored in a buffer to a higher-level medium access control (MAC) process, in sequential order based on a sequence number (SN) subfield of the data packets. A watchdog timer is activated upon encountering a missing data packet during the passing. Upon expiration of the watchdog timer, the wireless communication station transmits a delete block acknowledgment (DELBA) frame to terminate a block acknowledgment (ACK) agreement with an originator of the data packets.

### TECHNICAL FIELD

Embodiments pertain to communication networks. Some embodiments pertain to wireless devices operating in wireless local area networks (WLANs) in accordance with Institute of Electrical and Electronics Engineers (IEEE) 802.11 family of standards.

### BACKGROUND

The IEEE has adopted a set of standards for WLANs, known as 802.11. Under 802.11, a device, also known as a station (STA), may act as a receiver STA by receiving data packets from a transmitter or originator STA. The originator STA may occasionally lose, or “drop” packets, causing data starvation or other manifestations of data loss to occur at the receiver STA.

Accordingly, there is a general need for the receiver STA to perform methods to reduce or help prevent data starvation due to dropped data packets.

### BRIEF DESCRIPTION OF THE DRAWINGS

FIG. 1 illustrates a basic-service set (BSS) of two or more devices (STAs) in which example embodiments are implemented;

FIG. 2 is a flow diagram of a procedure to reduce data starvation in a wireless communication network, in accordance with some embodiments;

FIG. 3 illustrates a functional block diagram of a receiver station (STA), in accordance with some embodiments; and

FIG. 4 is a flow diagram of a procedure for receiving aggregate medium access control service data units (A-MSDUs) in accordance with some embodiments.

### DETAILED DESCRIPTION

The following description and the drawings sufficiently illustrate specific embodiments to enable those skilled in the art to practice them. Other embodiments may incorporate structural, logical, electrical, process, and other changes. Portions and features of some embodiments may be included in, or substituted for, those of other embodiments. Embodiments set forth in the claims encompass all available equivalents of those claims.

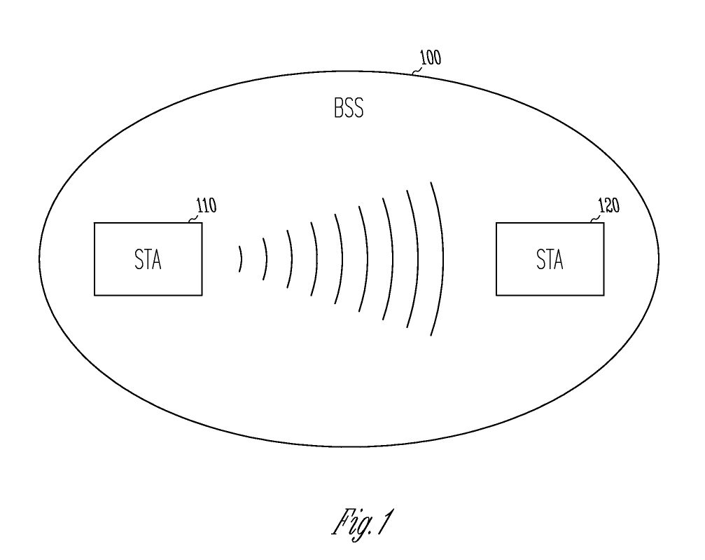

FIG. 1 illustrates a BSS 100, in accordance with some embodiments. The BSS 100 may operate in compliance with a standard of the IEEE 802.11 family of standards. The BSS 100 may include two or more wireless devices, or STAs 110, 120. Either or both of the STAs 110, 120 may operate concurrently or separately as an originator or receiver of data packets. For example, the STA 110 may operate as a transmitter, or originator, by transmitting data packets to at least one other receiver STA 120. The receiver STA 120 may acknowledge the data packets by transmitting an acknowledgement (ACK) to the originator STA 110.

A Block ACK mechanism may be implemented in accordance with a standard of the IEEE 802.11 family of standards to improve channel efficiency by aggregating several acknowledgements into one frame. The originator STA 110 may request that communications proceed under a Block ACK agreement by transmitting an add block acknowledgment (ADDBA) request to the receiver STA 120. The receiver STA 120 may accept the request by transmitting an ADDBA response frame to the originator STA 110.

Upon successful initialization of a Block ACK agreement between the originator STA 110 and the receiver STA 120, the originator STA 110 may transmit blocks of data packets to the receiver STA 120. The data packets may not be in order; for example, the data packets may not be received in an order according to corresponding sequence number (SN) subfields of the data packets. Accordingly, the receiver STA 120 may rearrange the data packets in sequence before passing the data packets to the next-highest medium access control (MAC) process. For example, the receiver STA 120 may reorder the data packets into sequential order before passing the data packets to an operating system (OS) or application for further processing of the data packets. The receiver STA 120 may utilize a buffer, hereinafter referred to as a “reordering buffer,” for reordering the data packets.

The reordering buffer, maintained for each Block ACK agreement between an originator STA 110 and a receiver STA, may include a plurality of data packets. The data packets may be, for example, MSDUs or A-MSDUs, according to a standard of the IEEE 802.11 family of standards. The reordering buffer may include a WinStart_{B} parameter or subfield. The WinStart_{B} subfield may indicate the value of the SN subfield of the first (in order of ascending SN) data packet that has not yet been received. The WinSize_{B} subfield indicates the size of the reception window (i.e., the number of data packets received in a window under the Block ACK agreement) determined at the time the Block ACK agreement is initialized. The number of data packets in the reordering buffer is limited according to WinSize_{B}. The reordering buffer may further include a WinEnd_{B} for indicating a highest expected SN for the reception window.

In accordance with current IEEE 802.11 standards, the receiver STA 120 may pass the data packets to the next-higher MAC process when the receiver STA 120 receives a complete sequence of data packets. The sequence of data packets may be indicated as complete, for example, when a data packet is received having an SN corresponding to the WinStart_{B} subfield, or when the reordering buffer becomes full. The receiver STA 120 may then pass the data packets up to the next-higher MAC process in order of increasing SN subfield values, starting with the data packet that has an SN corresponding to the starting data packet of a reordering buffer window. If there are no data packets in the reordering buffer for a next sequential SN value (hereinafter a “missing” SN value), the receiver STA 120 may keep the rest of the received data packets in the reordering buffer until the STA 120 receives a data packet with the missing SN value, or until the reordering buffer becomes full.

However, the originator STA 110 may drop or otherwise fail to transmit the data packet with the missing SN value, in which case the receiver STA 110 keeps the data packets in the reordering buffer until the reordering buffer becomes full. Depending on data transmission rates between the originator STA 110 and the receiver STA 120, the reordering buffer may take a long time to become full, and therefore no data packets may be transmitted to the next highest MAC process during that time. In such cases, the latency requirements of the next-highest MAC process may not be met. As an illustrative example, the receiver STA 120 may receive data at the rate of one data packet per second, and the reception window may allow for 64 data packets (WinSize_{B}=64). Therefore, the reordering buffer may not become full for more than one minute, and the next-highest MAC process may not receive data packets passed from the receiver STA 120 for more than one minute.

While IEEE 802.11 specifications state that the originator STA 110 is to perform recovery methods to prevent data starvation, some originator STAs nevertheless may not implement these recovery methods. The next-highest MAC process may therefore time out or otherwise function in a sub-optimal manner, and the user experience may become degraded.

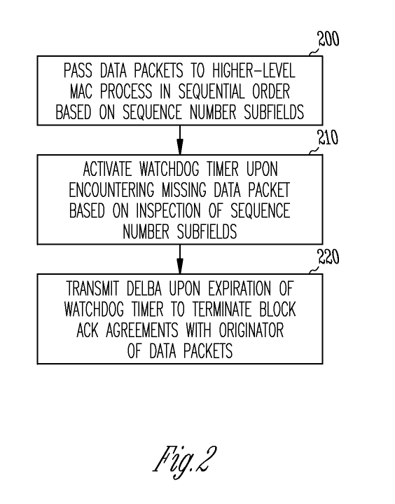

In accordance with some embodiments, the receiver STA 120 detects that data starvation may occur or has occurred, and the receiver STA 120 performs steps to recover from data starvation to deliver available data from the reordering buffer to the next-highest MAC process. FIG. 2 illustrates a method, performed by the receiver STA 120, for reducing data starvation.

Referring to FIG. 2, in operation 200, the receiver STA 120 may pass data packets stored in a buffer to a higher-level MAC process. The receiver STA 120 may pass the data packets in a sequential order based on SN subfields of the data packets. The buffer may be a reordering buffer configured in accordance with a standard of the IEEE 802.11 family of standards. As such, the buffer may include a first buffer subfield for storing an SN of a next data packet that has not been received (WinStart_{B}), and a second buffer subfield for indicating a highest expected SN (WinEnd_{B}), as described above with respect to FIG. 1. The passing may be triggered by the reception of a data packet with an SN corresponding to WinStart_{B}. The receiver STA 120 may reset a watchdog timer to an initial value, for example zero, upon passing the data packets to the higher-level MAC process.

In operation 210, the receiver STA 120 may activate the watchdog timer upon encountering a missing data packet. The receiver STA 120 may encounter the missing data packet based on an inspection of the SN subfields during the passing operation 200.

Upon encountering the missing data packet, the STA 120 may first determine whether the reordering buffer is empty before activating the watchdog timer. If the receiver STA 120 determines that the reordering buffer is empty (i.e., if there are no data packets waiting for transmission to the next higher-level MAC process), there may be no starvation condition imminent. Therefore, the receiver STA 120 may not activate the watchdog timer, and the receiver STA 120 may deactivate the watchdog timer in the case that the watchdog timer was already activated. On the other hand, if the receiver STA 120 determines that the reordering buffer is not empty, the receiver STA 120 may activate the watchdog timer, because there may be a starvation condition imminent.

In operation 220, the receiver STA 120 may transmit, upon expiration of the watchdog timer, a delete block acknowledgment (DELBA) frame to terminate a block ACK agreement with an originator STA 110 of the data packets. Additionally, upon expiration of the watchdog timer, the receiver STA 120 may pass any data packets in the reordering buffer to the higher-level MAC process. The receiver STA 120 may periodically check for expiration of the watchdog timer, and perform operation 220 upon expiration of the watchdog timer. When the block ACK agreement is terminated, the originator STA 110 may be triggered to re-establish the block ACK agreement, thereby re-setting reception windows and other parameters of the reordering buffer used by the receiver STA 120. The originator STA 110 may then resume transmission of data packets under the block ACK agreement. In this way, reordering buffer starvation may be limited to a time duration of the watchdog timer.

In some embodiments, the receiver STA 120 may set a time duration for the watchdog timer based on criteria including, for example, the latency requirements of the higher-level MAC process or the transmission rates for communications between the receiver STA 120 and the originator STA 110.

The receiver STA 120 may receive at least one additional data packet subsequent to the activation of the watchdog timer but before expiration of the activated watchdog timer. The receiver STA 120 may store the additional data packet in the reordering buffer. Upon expiration of the watchdog timer, the receiver STA 120 may pass any data packets in the reordering buffer to the higher-level MAC process upon expiration of the watchdog timer.

The receiver STA 120 may further activate or deactivate the watchdog timer based on the SN of received data packets other than the WinStart_{B} data packet. If the receiver STA 120 receives a data packet with an SN greater than WinStart_{B} but less than or equal to WinEnd_{B}, the receiver STA 120 may activate the watchdog timer, if the watchdog timer is not already activated. Additionally, if the receiver STA 120 receives a data packet with an SN greater than WinEnd_{B} and less than WinStart_{B}+2¹¹, this may indicate that data packet SNs have incremented past the upper-limit SN (i.e., the data packet SNs have “wrapped around” past zero). In at least this case, the receiver STA 120 may pass all data packets currently in the reordering buffer up to the next higher-level MAC process, in order of incrementing SN, deactivate the watchdog timer if it is active, and reset the watchdog timer to an initial value.

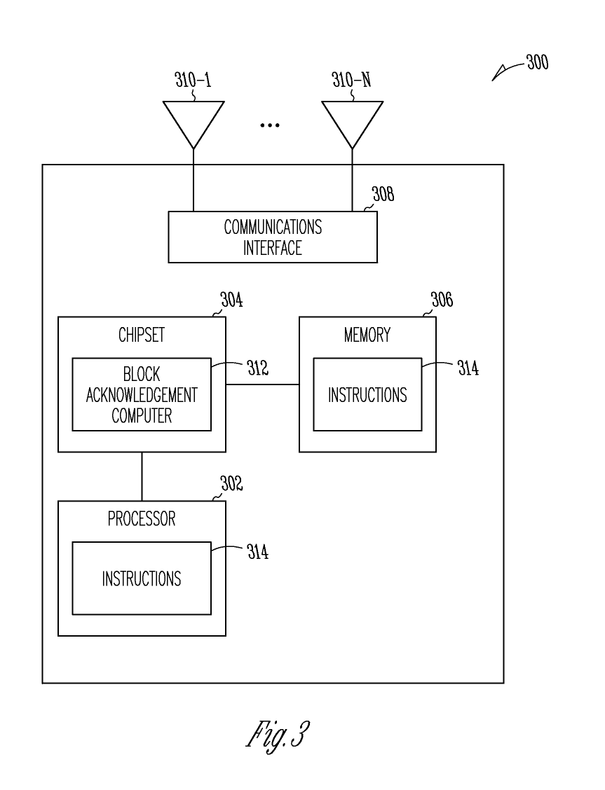

FIG. 3 illustrates a functional block diagram of a STA 300, in accordance with some embodiments. The STA 300 may be suitable as a receiver STA 120 (FIG. 1). The STA 300 may support methods for reducing or eliminating data starvation in a wireless communication network, in accordance with embodiments. STA 300 may include a processor 302, which uses chipset 304 to access on-chip state memory 306, as well as a communications interface 308. In one embodiment, memory 306 includes, but is not limited to, random access memory (RAM), dynamic RAM (DRAM), static RAM (SRAM), synchronous DRAM (SDRAM), double data rate (DDR) SDRAM (DDR-SDRAM), or any device capable of supporting high-speed buffering of data.

In at least one embodiment, the communications interface 308 is, for example, a wireless Physical Layer (PHY), which operates according to a multiple input/multiple output (MIMO) operation. The STA 300 may include multiple transmit and receive antennas 310-1 through 310-N, where N is a natural number. The chipset 304 may incorporate therein Block Acknowledgment Logic 312 to, for example, process requests for initiation of Block ACK agreements. In an embodiment, MAC layer functionality is provided by the chipset 304. For example, the chipset 304 may provide MAC layer functionality to configure an ADDBA response frame. In an embodiment, PHY layer functionality is provided by the communications interface 308. For example, the communications interface 308 may transmit the ADDBA response frame to an originator station and receive an ADDBA request frame from the originator station. The communications interface 308 may receive data packets from the originator station.

Memory 306 may be configured to store, among other things, the reordering buffer, described previously with respect to FIG. 2. The processor 302 may be configured to pass data packets to a higher-level MAC process upon receiving a data packet with an initial SN, with the passing being performed in sequential order based on the SN subfields of the data packets. The processor 302 may further be configured to activate a watchdog timer upon encountering a missing data packet. The processor 302 may encounter a missing data packet based on an inspection of the SN subfields during the passing. The processor 302 may monitor the watchdog timer. Upon expiration of the watchdog timer, the communications interface 308 may terminate a block ACK agreement with the originator station by transmitting a DELBA frame to the originator station.

The communications interface 308 may receive additional data packets after the activation of the watchdog timer but before expiration of the watchdog timer. The processor 302 may store these additional data packets in the reordering buffer in, for example, the memory 306. The processor 302 may pass these additional data packets sequentially, based on SN numbers, to the next-highest MAC process upon expiration of the watchdog timer. As described previously, the reordering buffer may include a number of data packets limited to a number corresponding to a size (WinSize_{B}) of the block ACK reception window. The reordering buffer may include a first buffer subfield for storing an SN of a next data packet that has not been received (WinStart_{B}) and a second buffer subfield for indicating a highest expected SN (WinEnd_{B}). In an embodiment, WinStart_{B} corresponds to the initial SN that triggers the passing of data packets to the next-highest MAC process.

In an embodiment, the processor 302 is further configured to determine whether the reordering buffer is empty upon encountering a missing data packet. If the reordering buffer is empty, there is no data waiting to be passed to the next-highest MAC process, and, therefore, the processor 302 does not activate the watchdog timer. However, if the reordering buffer is not empty, the processor 302 activates the watchdog timer so that data may be passed to the next-highest MAC process upon expiration of the watchdog timer.

Embodiments may be implemented in one or a combination of hardware, firmware and software. Embodiments may also be implemented as instructions 314 stored on a computer-readable storage device, which may be read and executed by at least one processor 302 to perform the operations described herein. In some embodiments, the instructions 314 are stored on the processor 302 or the memory 306 such that the processor 302 and the memory 306 act as computer-readable mediums. A computer-readable storage device may include any non-transitory mechanism for storing information in a form readable by a machine (e.g., a computer). For example, a computer-readable storage device may include ROM, RAM, magnetic disk storage media, optical storage media, flash-memory devices, and other storage devices and media.

Although the STA 300 is illustrated as having several separate functional elements, one or more of the functional elements may be combined and may be implemented by combinations of software-configured elements, such as processing elements including digital signal processors (DSPs) and/or other hardware elements. For example, some elements may comprise one or more microprocessors, DSPs, application specific integrated circuits (ASICs), radio-frequency integrated circuits (RFICs), and combinations of various hardware and logic circuitry for performing at least the functions described herein. In some embodiments, the functional elements of the STA 300 may refer to one or more processes operating on one or more processing elements.

Antennas 310-1 through 310-N may comprise one or more directional or omnidirectional antennas, including, for example, dipole antennas, monopole antennas, patch antennas, loop antennas, microstrip antennas, or other types of antennas suitable for transmission of RF signals. In some embodiments, instead of two or more antennas, a single antenna with multiple apertures may be used. In these embodiments, each aperture may be considered a separate antenna. In some MIMO embodiments, antennas 310-1 through 310-N may be effectively separated to take advantage of spatial diversity and the different channel characteristics that may result between each of antennas 310-1 through 310-N and the antennas of an originator STA. In some MIMO embodiments, antennas 310-1 through 310-N may be separated by up to 1/10 of a wavelength or more.

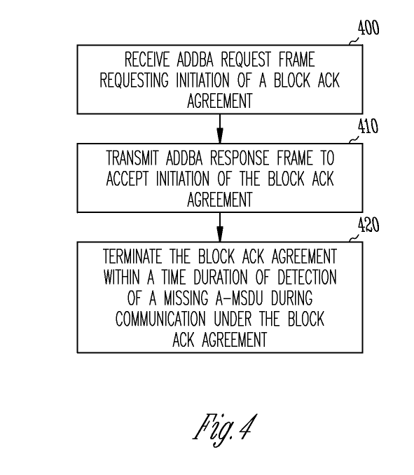

FIG. 4 illustrates a method, performed by the receiver STA 120, for receiving A-MSDUs. In operation 400, the receiver STA 120 receives an ADDBA request frame requesting initiation of a block ACK agreement. In operation 410, the receiver STA 120 transmits an ADDBA response frame to accept initiation of the block ACK agreement. In operation 420, the receiver STA 120 terminates the block ACK agreement within a time duration of detection of a missing A-MSDU during communication under the block ACK agreement.

The Abstract is provided to comply with 37 C.F.R. Section 1.72(b) requiring an abstract that will allow the reader to ascertain the nature and gist of the technical disclosure. It is submitted with the understanding that it will not be used to limit or interpret the scope or meaning of the claims. The following claims are hereby incorporated into the detailed description, with each claim standing on its own as a separate embodiment.

What is claimed is:

1. A method to reduce data starvation in a wireless communication network, the method comprising:
passing data packets stored in a buffer to a higher-level medium access control (MAC) process, the passing being performed in a sequential order based on sequence number (SN) subfields of the data packets;
activating a watchdog timer upon encountering a missing data packet, the encountering being based on an inspection of the SN subfields during the passing; and
transmitting, upon expiration of the watchdog timer, a delete block acknowledgment (DELBA) frame to terminate a block acknowledgment (ACK) agreement with an originator of the data packets.

2. The method of claim 1, further comprising:
receiving at least one data packet subsequent to the activation of the watchdog timer and storing the at least one data packet in the buffer;
passing data packets of the buffer to the higher-level MAC process upon expiration of the watchdog timer.

3. The method of claim 1, wherein a duration for the watchdog timer is determined based on a latency tolerance of the higher-level MAC process.

4. The method of claim 3, further comprising:
determining whether the buffer is empty upon encountering a missing data packet; and
wherein the activating activates the watchdog timer if the determining determines that the buffer is not empty.

5. The method of claim 3, further comprising:
deactivating the watchdog timer if the watchdog timer is active and the determining determines that the buffer is empty.

6. The method of claim 1, wherein the buffer of data packets is a reordering buffer configured in accordance with a standard of the Institute of Electrical and Electronics Engineers (IEEE) 802.11 family of standards.

7. The method of claim 1, wherein the buffer has included therein a first buffer subfield for storing an SN of a next data packet that has not been received (WinStart_{B}); and
a second buffer subfield for indicating a highest expected SN (WinEnd_{B}); and
wherein the passing is triggered by reception of a data packet with an SN subfield corresponding to the SN stored in the first buffer subfield.

8. The method of claim 7, further comprising:
activating the watchdog timer upon reception of a data packet with an SN subfield greater than the SN stored in the first buffer subfield and less than or equal to the SN stored in the second buffer subfield; and
passing the data packets in the buffer to the next-highest MAC process upon expiration of the watchdog timer.

9. A wireless communication station comprising:
a medium access control (MAC) layer to configure an add block acknowledge (ADDBA) response frame;
physical layer (PHY) circuitry to
transmit the ADDBA response frame to an originator station,
receive an ADDBA request frame from the originator station, and
receive data packets from the originator station; and
one or more processors to
pass data packets to a higher-level MAC process upon receiving a data packet with an initial sequence number SN, the passing being performed in sequential order based on the SN subfields of the data packets; and
activate a watchdog timer upon encountering a missing data packet, the encountering being based on an inspection of the SN subfields during the passing.

10. The wireless communication station of claim 9, wherein the processor is further configured to monitor the watchdog timer, and wherein the PHY layer is further configured to terminate a block acknowledgement ACK agreement with the originator station by transmitting a delete block acknowledgment (DELBA) frame to the originator station upon expiration of the watchdog timer.

11. The wireless communication station of claim 10, wherein the PHY layer is further configured to receive additional data packets after the activation of the watchdog timer; and
the processor is further configured to
store the additional data packets in the reordering buffer; and
pass the additional data packets sequentially based on SN numbers to the next-highest MAC process upon expiration of the watchdog timer.

12. The wireless communication station of claim 11, wherein the buffer includes a number of data packets corresponding to a size of a block ACK reception window, the reordering buffer having included therein a first buffer subfield for storing an SN of a next data packet that has not been received (WinStart_{B}) and a second buffer subfield for indicating a highest expected SN (WinEnd_{B}).

13. The wireless communication station of claim 12, wherein the initial SN that triggers the passing corresponds to WinStart_{B}.

14. The wireless communication station of claim 9, wherein the processor is further configured to store data packets received from the originator station in a buffer, the data packets including corresponding SN subfields.

15. The wireless communication station of claim 14, wherein the processor is further configured to:
determine whether the buffer is empty upon encountering a missing data packet;
deactivate the watchdog timer if the buffer is empty; and
activate the watchdog timer if the buffer is not empty.

16. A method for receiving aggregate medium access control service data units (A-MSDUs), the method comprising:
receiving an add block acknowledge (ADDBA) request frame requesting initiation of a block acknowledge (ACK) agreement;
transmitting an ADDBA response frame to accept initiation of the block ACK agreement; and
terminating the block ACK agreement within a time duration of detection of a missing A-MSDU during communication under the block ACK agreement.

17. The method of claim 16, wherein the missing A-MSDU is discovered during a passing of A-MSDUs to a higher-level MAC process based on an examination, during the passing, of sequence numbers (SNs) corresponding to each of the A-MSDUs.

18. A system comprising:
an antenna arranged to receive data packets from an originator station;
a processor arranged to
store the received data packets in a reordering buffer in a memory, the data packets including corresponding sequence number (SN) subfields,
pass the data packets of the reordering buffer to a higher-level medium access control (MAC) process upon receiving a data packet with an initial SN, the passing being performed in a sequential order based on the SN subfields of the data packets; and
activate a watchdog timer upon encountering a missing data packet, the encountering being based on an inspection of the SN subfields during the passing; and
a memory arranged to maintaining the reordering buffer, the reordering buffer including a number of data packets corresponding to a size of a block acknowledgement (ACK) reception window, the reordering buffer having included therein a first buffer subfield for storing an SN of a next data packet that has not been received (WinStart_{B}) and a second buffer subfield for indicating a highest expected SN (WinEnd_{B}); and
wherein the initial SN that triggers the passing corresponds to WinStart_{B}.

19. The system of claim 18, wherein the processor is further configured to:
monitor the watchdog timer; and
terminate a block ACK agreement with the originator station by transmitting a delete block acknowledgment (DELBA) frame to the originator station upon expiration of the watchdog timer.

20. The system of claim 18, wherein the processor is further configured to:
receive data packets after the activation of the watchdog timer;
store the data packets in the reordering buffer; and
pass the data packets to the next-highest MAC process upon expiration of the watchdog timer.

21. The system of claim 18, wherein the processor is further configured to:
determine whether the buffer is empty upon encountering a missing data packet;
deactivate the watchdog timer if the buffer is empty; and
activate the watchdog timer if the buffer is not empty.

22. A computer-readable medium comprising instructions that, when implemented on a receiver station, cause the receiver station to:
pass received data packets to a higher-level medium access control (MAC) process sequentially, based on sequence numbers (SNs) of the data packets;
activate a watchdog timer upon encountering a missing data packet, the encountering being based on an inspection of the SN subfields during the passing; and
terminate a block acknowledgement (ACK) agreement with an originator of the data packets by transmitting a delete block acknowledgment (DELBA) frame to the originator of the data packets.

23. The computer-readable medium of claim 22, comprising further instructions that, when implemented on the receiver station, cause the receiver station to:
store received data packets in a reordering buffer, wherein the passing causes data packets to be emptied from the reordering buffer; and
wherein the watchdog timer is activated if the reordering buffer is not empty.

24. The computer-readable medium of claim 23, comprising further instructions that, when implemented on the receiver station, cause the receiver station to:
receive additional data packets subsequent to activation of the watchdog timer;
store the additional data packets in the reordering buffer; and
pass the additional data packets to the higher-level MAC process upon expiration of the watchdog timer.
